(19) United States
(12) Patent Application Publication
(10) Pub. No.: US 2020/0061959 A1
(43) Pub. Date: Feb. 27, 2020

(54) Multilayer composite material having light-transmission and tensile properties

(71) Applicant: Seaman Corporation, Wooster, OH (US)

(72) Inventors: Paul Joseph Roe, Granger, IN (US); Frank E. BRADENBURG, Wooster, OH (US)

(21) Appl. No.: 16/549,014

(22) Filed: Aug. 23, 2019

Related U.S. Application Data
(60) Provisional application No. 62/837,429, filed on Apr. 23, 2019.
(60) Provisional application No. 62/765,379, filed on Aug. 23, 2018.

(51) Int. Cl. B32B 5/02; B32B 7/12; B32B 27/30; C09J 127/06; C09J 11/06; D01F 6/62; D01F 1/04; C09J 11/04

(52) U.S. Cl. CPC B32B 5/024; B32B 7/12; B32B 27/304; B32B 27/308; C09J 127/06; C09J 11/06; B32B 2307/416; D01F 1/04; C09J 11/04; B32B 2255/10; B32B 2255/26; B32B 2307/3065; D01F 6/62

(57) ABSTRACT

A multilayer composite material having a core layer that is a saturated fabric, the saturated fabric including woven polyethylene-terephthalate yarns and a polyvinyl-chloride adhesive between the woven yarns; the core layer having a first side and a second side; the core-layer first side being attached to a first side of a first polyvinyl-chloride layer that includes a flame-retardant component; the core-layer second side being attached to a first side of a second polyvinyl-chloride layer that includes a flame-retardant component; the second side of the second polyvinyl-chloride layer being attached to a first side of a low-emissivity layer that includes a component that reduces the amount of infrared light that can pass through the low-emissivity layer; and the low-emissivity layer having a second side that is attached to a first side of an ultraviolet-light inhibiting layer that includes an ultraviolet-light protectant that either absorbs ultraviolet light or reflects ultraviolet light, wherein the multilayer composite material has a range of light transmission from 30% to 90%, and wherein the multilayer composite material has a tensile strength ranging from 150 pli to 650 pli.

### CROSS-REFERENCE TO RELATED APPLICATIONS

This patent application claims priority to both of the following U. S. provisional patent applications: U.S. provisional patent application Ser. No. 62/765,379 having a filing date of Aug. 23, 2018; and U.S. provisional patent application Ser. No. 62/837,429 having a filing date of Apr. 23, 2019.

The subject matter of both provisional patent applications is incorporated by reference into this patent application.

### BACKGROUND OF THE INVENTION

Many architectural applications require high light-transmission or even clear building materials. This applies to everything from: party-tent window panels, green houses that require sections to have very good light-transmission properties, and structures having large gathering spaces such as stadiums and airport terminals.

There remains a need for building materials that are durable and have high light-transmission properties.

### BRIEF SUMMARY OF THE INVENTION

A multilayer composite material having a core layer that is a saturated fabric, the saturated fabric including woven polyethylene-terephthalate yarns and a polyvinyl-chloride adhesive between the woven yarns; the core layer having a first side and a second side; the core-layer first side being attached to a first side of a first polyvinyl-chloride layer that includes a flame-retardant component; the core-layer second side being attached to a first side of a second polyvinyl-chloride layer that includes a flame-retardant component; the second side of the second polyvinyl-chloride layer being attached to a first side of a low-emissivity layer that includes a component that reduces the amount of infrared light that can pass through the low-emissivity layer; and the low-emissivity layer having a second side that is attached to a first side of an ultraviolet-light inhibiting layer that includes an ultraviolet-light protectant that either absorbs ultraviolet light or reflects ultraviolet light, wherein the multilayer composite material has a range of light transmission from 30% to 90%, and wherein the multilayer composite material has a tensile strength ranging from 150 pli to 650 pli.

A multilayer composite material having: a core layer that is a saturated fabric, the saturated fabric including woven polyethylene-terephthalate yarns and a polyvinyl-chloride adhesive between the woven yarns; the core layer having a first side and a second side; the core-layer first side being attached to a first side of a first polyvinyl-chloride layer that includes a flame-retardant component; the core-layer second side being attached to a first side of a second polyvinyl-chloride layer that includes a flame-retardant component; the second side of the second polyvinyl-chloride layer being attached to a first side of an ultraviolet-light inhibiting layer that includes an ultraviolet-light protectant that either absorbs ultraviolet light or reflects ultraviolet light, wherein the multilayer composite material has a range of light transmission from 30% to 90%, and wherein the multilayer composite material has a tensile strength ranging from 150 pli to 650 pli.

A multilayer composite material having: a core layer that is an open weave polyester fabric saturated with cured vinyl plastisol; the core layer having a first side and a second side; the first side of the core layer being attached to a first side of a first vinyl film; the second side of the core layer being attached to a first side of a second vinyl film; the first vinyl film having a second side that is attached to a first side of a first protective layer that is either a film or lacquer; and the second vinyl film having a second side that is attached to a first side of a second protective layer that is either a film or lacquer.

A multilayer composite material having: a core layer that is a saturated fabric, the saturated fabric including an open weave of polyethylene-terephthalate yarns and cured vinyl plastisol between the yarns; the core layer having a first side and a second side; the first side of the core layer being attached to a first side of a first vinyl layer; the second side of the core layer being attached to a first side of a second vinyl layer; the first vinyl layer having a second side that is attached to a first side of a first protective layer that is either a film or lacquer; and the second vinyl film having a second side that is attached to a first side of a second protective layer that is either a film or lacquer.

### BRIEF DESCRIPTION OF THE SEVERAL VIEWS OF THE DRAWING

FIG. 1 is a cross-sectional view of an embodiment.

FIG. 2 is a cross-sectional view of an embodiment.

FIG. 3 is a cross-sectional view of an embodiment.

FIG. 4 is a cross-sectional view of an embodiment.

FIG. 5 is a cross-sectional view of an embodiment.

FIG. 6 is a cross-sectional view of an embodiment.

### DETAILED DESCRIPTION OF THE INVENTION

Embodiments are directed to a multilayer composite material having tensile-strength properties and light-transmission properties that make it useful in many building applications. In describing the embodiments, each figure has been used to show a particular embodiment's cross section; also shown are the various layers and their respective positions within the embodiment. The relative thicknesses of the layers are not to scale. Useful compositions for each of the layers is also provided.

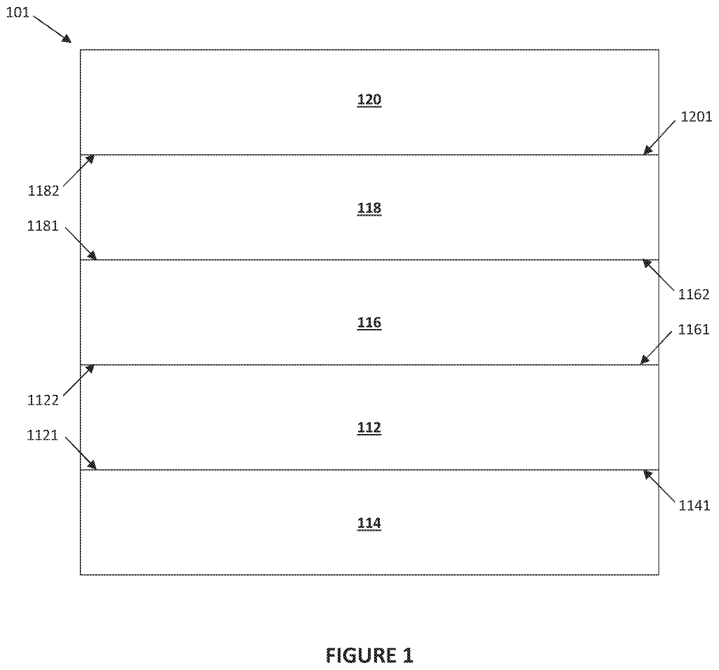

FIG. 1 shows an embodiment that is multilayer composite material 101. Core layer 112 is a saturated fabric, the saturated fabric including woven polyethylene-terephthalate yarns and a polyvinyl-chloride adhesive between the woven yarns. Core layer 112 has first side 1121 and second side 1122. Core-layer first side 1121 is attached to first side 1141 of first polyvinyl-chloride layer 114 that includes a flame-retardant component. Core-layer second side 1122 is attached to first side 1161 of second polyvinyl-chloride layer 116 that includes a flame-retardant component. Second side 1162 of second polyvinyl-chloride layer 116 is attached to first side 1181 of low-emissivity layer 118 that includes a component that reduces the amount of infrared light that can pass through low-emissivity layer 118. Low-emissivity layer 118 has second side 1182 that is attached to first side 1201 of ultraviolet-light inhibiting layer 120 that includes an ultraviolet-light protectant that either absorbs ultraviolet light or reflects ultraviolet light.

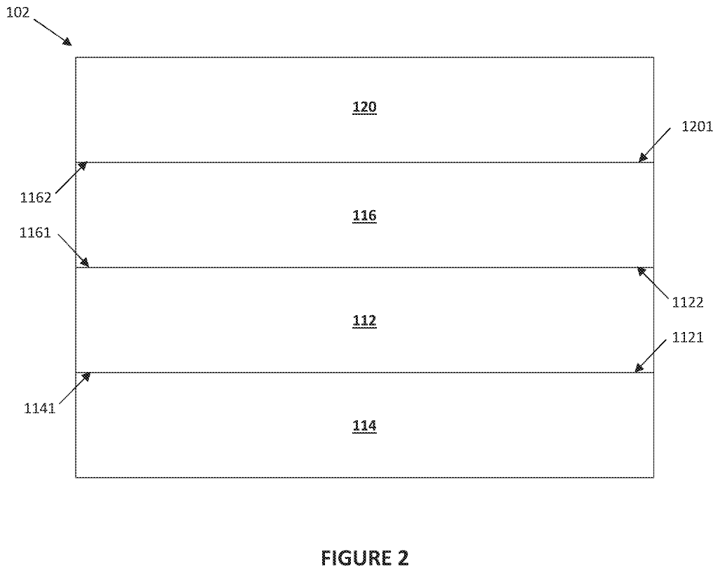

FIG. 2 shows an embodiment that is multilayer composite material 102. Core layer 112 is a saturated fabric, the saturated fabric including woven polyethylene-terephthalate yarns and a polyvinyl-chloride adhesive between the woven yarns. Core layer 112 has first side 1121 and second side 1122. Core-layer first side 1121 is attached to first side 1141 of first polyvinyl-chloride layer 114 that includes a flame-retardant component. Core-layer second side 1122 is attached to first side 1161 of second polyvinyl-chloride layer 116 that includes a flame-retardant component. Second side 1162 of second polyvinyl-chloride layer 116 is attached to first side 1201 of ultraviolet-light inhibiting layer 120 that includes an ultraviolet-light protectant that either absorbs ultraviolet light or reflects ultraviolet light.

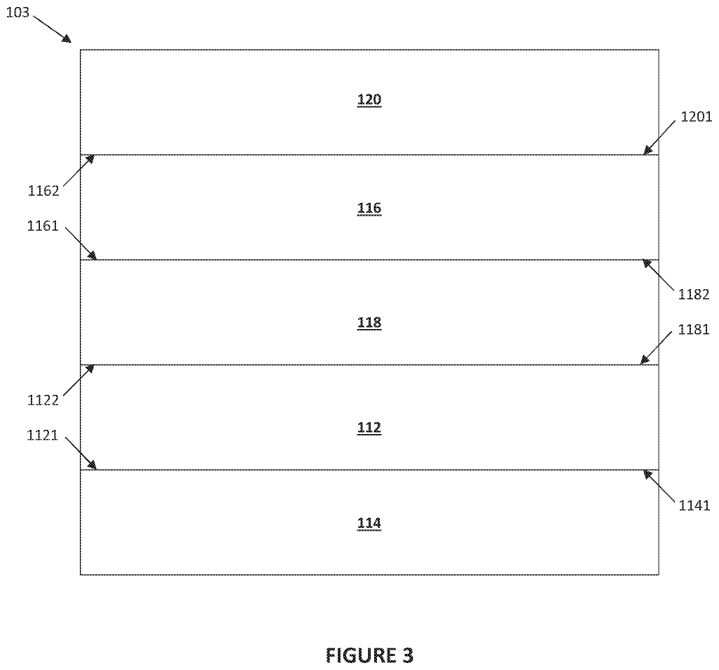

FIG. 3 shows an embodiment that is multilayer composite material 103. Core layer 112 is a saturated fabric, the saturated fabric including woven polyethylene-terephthalate yarns and a polyvinyl-chloride adhesive between the woven yarns. Core layer 112 has first side 1121 and second side 1122. Core-layer first side 1121 is attached to first side 1141 of first polyvinyl-chloride layer 114 that includes a flame-retardant component. Core-layer second side 1122 is attached to first side 1181 of low-emissivity layer 118 that includes a component that reduces the amount of infrared light that can pass through low-emissivity layer 118. Low-emissivity layer 118 has second side 1182 that is attached to first side 1161 of second polyvinyl-chloride layer 116 that includes a flame-retardant component. Second side 1162 of second polyvinyl-chloride layer 116 is attached to first side 1201 of ultraviolet-light inhibiting layer 120 that includes an ultraviolet-light protectant that either absorbs ultraviolet light or reflects ultraviolet light.

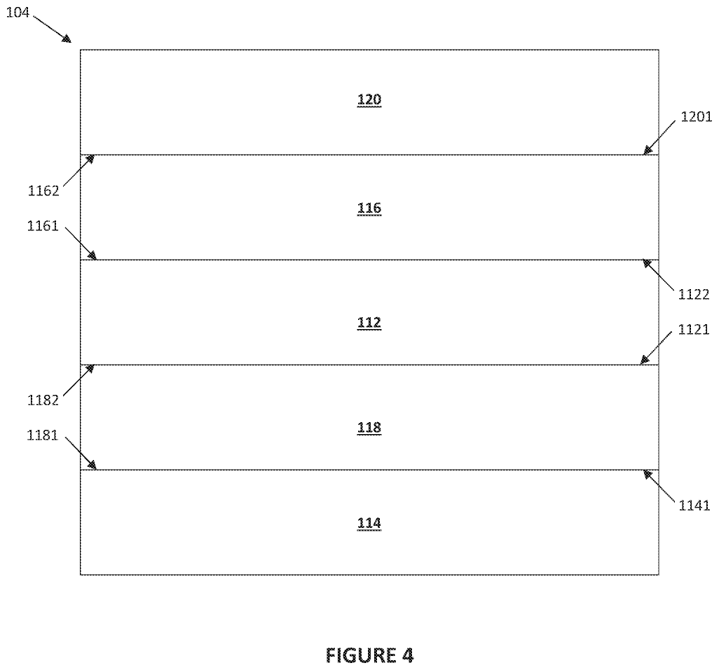

FIG. 4 shows an embodiment that is multilayer composite material 104. Core layer 112 is a saturated fabric, the saturated fabric including woven polyethylene-terephthalate yarns and a polyvinyl-chloride adhesive between the woven yarns. Core layer 112 has first side 1121 and second side 1122. Core-layer first side 1121 is attached to second side 1182 of low-emissivity layer 118 that includes a component that reduces the amount of infrared light that can pass through low-emissivity layer 118. Low-emissivity layer 118 has first side 1181 that is attached to first side 1141 of first polyvinyl-chloride layer 114 that includes a flame-retardant component. Core-layer second side 1122 is attached to first side 1161 of second polyvinyl-chloride layer 116 that includes a flame-retardant component. Second side 1162 of second polyvinyl-chloride layer 116 is attached to first side 1201 of ultraviolet-light inhibiting layer 120 that includes an ultraviolet-light protectant that either absorbs ultraviolet light or reflects ultraviolet light.

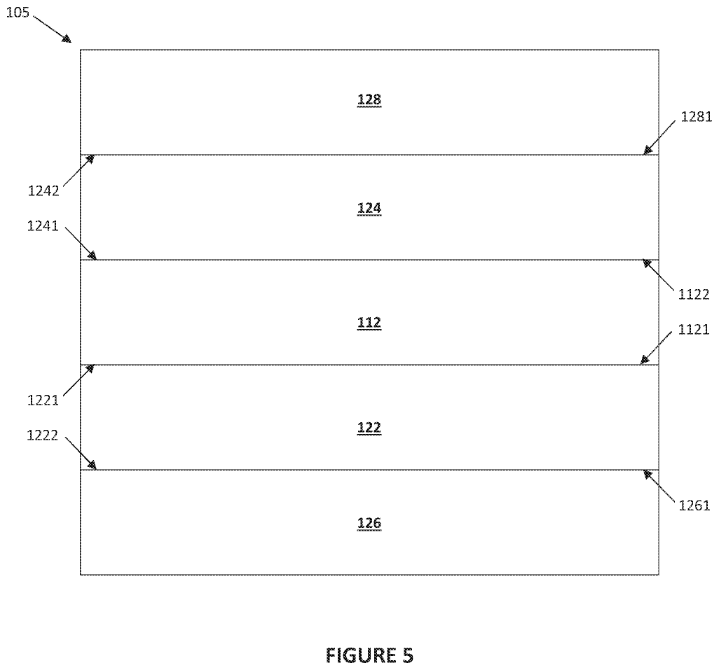

FIG. 5 shows an embodiment that is multilayer composite material 105. Core layer 112 is an open weave polyester fabric saturated with cured vinyl plastisol. Core layer 112 has first side 1121 and second side 1122. First side 1121 of core layer 112 is attached to first side 1221 of first vinyl film 122. Second side 1122 of core layer 112 is attached to first side 1241 of second vinyl film 124. First vinyl film 122 has second side 1222 that is attached to first side 1261 of first protective layer 126 that is either a film or lacquer. Second vinyl film 124 has second side 1242 that is attached to first side 1281 of second protective layer 128 that is either a film or lacquer.

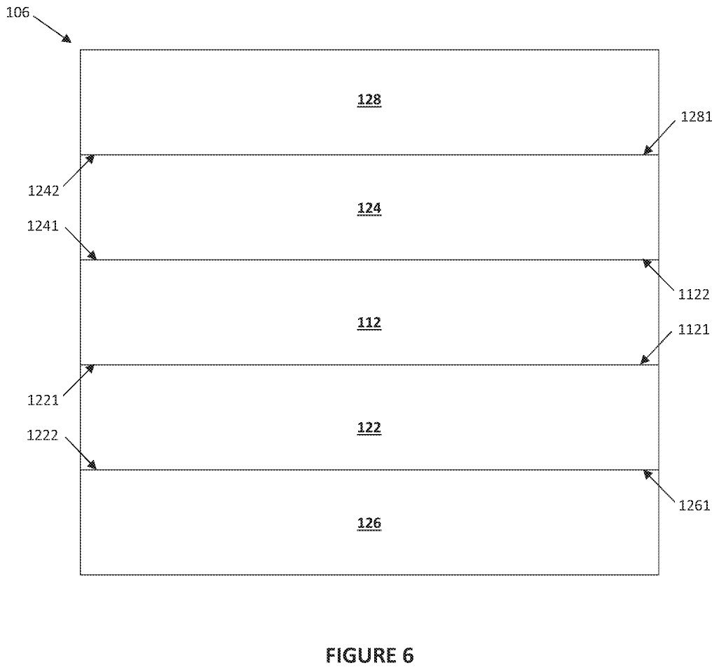

FIG. 6 shows an embodiment that is multilayer composite material 106. Core layer 112 is a saturated fabric, the saturated fabric including an open weave of polyethylene-terephthalate yarns and cured vinyl plastisol between the woven yarns. Core layer 112 has first side 1121 and second side 1122. First side 1121 of core layer 112 is attached to first side 1221 of first vinyl layer 122. Second side 1122 of core layer 112 is attached to first side 1241 of second vinyl layer 124. First vinyl layer 122 has second side 1222 that is attached to first side 1261 of first protective layer 126 that is either a film or lacquer. Second vinyl layer 124 has second side 1242 that is attached to first side 1281 of second protective layer 128 that is either a film or lacquer.

As a non-limiting example, a saturated fabric can be manufactured by using heat and pressure to press a substance into a fabric such that the substance is then between the woven yarns within the fabric. Another known method for manufacturing a saturated fabric includes the steps of soaking a fabric in a substance for a period of time and then removing the fabric from the substance and allowing that substance to cure within the woven fibers. Any known method for manufacturing a saturated fabric can be used.

In embodiments, the polyethylene-terephthalate yarns include titanium dioxide. In other embodiments, the polyethylene-terephthalate yarns do not include titanium dioxide. Any known method can be used for compounding titanium dioxide into polyethylene-terephthalate, and any known method can be used to manufacture polyethylene-terephthalate yarns.

In embodiments, the polyvinyl-chloride adhesive includes: a polyvinyl-chloride resin; a phthalate plasticizer; a zero-tint antimony trioxide; and an ultraviolet-light protectant that either absorbs ultraviolet light or reflects ultraviolet light. In other embodiments, the polyvinyl-chloride adhesive includes: a polyvinyl-chloride resin; a phosphite plasticizer; and an ultraviolet-light protectant that either absorbs ultraviolet light or reflects ultraviolet light. Polyvinyl-chloride adhesives are known and methods for incorporating additives or fillers into polyvinyl chloride are known.

Any known low emissivity coating, layer, or component that reduces the amount of infrared light passing through a layer can be useful in the embodiments.

Any known flame retardant can be useful, and methods for incorporating a flame retardant into polyvinyl chloride are known.

In embodiments, the ultraviolet-light inhibiting layer has acrylic or polyvinylidene fluoride that also includes an ultraviolet-light protectant that either absorbs ultraviolet light or reflects ultraviolet light. In other embodiments, the ultraviolet-light inhibiting layer has a polyvinyl fluoride resin that also includes an ultraviolet-light protectant that either absorbs ultraviolet light or reflects ultraviolet light. In an embodiment, the ultraviolet-light inhibiting layer has a polyvinyl-fluoride film that includes an ultraviolet-light protectant that either absorbs ultraviolet light or reflects ultraviolet light. Any known ultraviolet-light protectant can be used. Polyvinyl-fluoride films are commercially available, and as a nonlimiting example, DuPont distributes polyvinyl-fluoride films under the trademark TEDLAR® that are useful in the embodiments.

In embodiments, the first protective layer is a lacquer selected from the group consisting of acrylic, a mixture of polyvinylchloride and acrylic, urethane, fluoropolymer, and combinations thereof. In embodiments, the first protective layer is a polyvinyl-fluoride film.

In embodiments, the second protective layer is a lacquer selected from the group consisting of acrylic, a mixture of polyvinylchloride and acrylic, urethane, fluoropolymer, and combinations thereof. In embodiments, the second protective layer is a polyvinyl-fluoride film.

In embodiments, the multilayer composite material has a range of light transmission from 30% to 90%. In embodiments, the multilayer composite material has a range of light transmission from 50% to 90%. In embodiments, the multilayer composite material has a range of light transmission from 70% to 90%. In embodiments, the multilayer composite material has a light transmission of at least 30%. In embodiments, the multilayer composite material has a light transmission of at least 50%. In embodiments, the multilayer composite material has a light transmission of at least 70%. In embodiments, the multilayer composite material has a light transmission of at least 80%.

In embodiments, the multilayer composite material has a tensile strength ranging from 150 pli to 650 pli. In embodiments, the multilayer composite material has a tensile strength ranging from 350 pli to 650 pli. In embodiments, the multilayer composite material has a tensile strength ranging from 450 pli to 650 pli. In embodiments, the multilayer composite material has a tensile strength of at least 150 pli. In embodiments, the multilayer composite material has a tensile strength of at least 350 pli. In embodiments, the multilayer composite material has a tensile strength of at least 450 pli. In embodiments, the multilayer composite material has a tensile strength of at least 550 pli.

As a non-limiting example, the embodiments can be manufactured by arranging the layers as shown in the figures and then applying heat and pressure to the arranged layers using a known hot-press machine. In embodiments, one or more adhesives can be used to attach one layer to another.

Compounded polymeric layers having: i) a flame-retardant component, ii) a component that reduces the amount of infrared light that can pass through the low-emissivity layer iii) an ultraviolet-light protectant that either absorbs ultraviolet light or reflects ultraviolet light, or iv) combinations thereof, can be compounded using known methods.

Persons of ordinary skill in the art will be able to manufacture the embodiments using known manufacturing methods without having to exercise undue experimentation.

What is claimed is:

1. A multilayer composite material comprising:
a core layer that is a saturated fabric, the saturated fabric including woven polyethylene-terephthalate yarns and a polyvinyl-chloride adhesive between the woven yarns;
the core layer having a first side and a second side;
the core-layer first side being attached to a first side of a first polyvinyl-chloride layer that includes a flame-retardant component;
the core-layer second side being attached to a first side of a second polyvinyl-chloride layer that includes a flame-retardant component;
the second side of the second polyvinyl-chloride layer being attached to a first side of a low-emissivity layer that includes a component that reduces the amount of infrared light that can pass through the low-emissivity layer; and
the low-emissivity layer having a second side that is attached to a first side of an ultraviolet-light inhibiting layer that includes an ultraviolet-light protectant that either absorbs ultraviolet light or reflects ultraviolet light,
wherein the multilayer composite material has a range of light transmission from 30% to 90%, and
wherein the multilayer composite material has a tensile strength ranging from 150 pli to 650 pli.

2. The multilayer composite material of claim 1, wherein the polyethylene-terephthalate yarns include titanium dioxide.

3. The multilayer composite material of claim 1, wherein the polyethylene-terephthalate yarns do not include titanium dioxide.

4. The multilayer composite material of claim 1, wherein the polyvinyl-chloride adhesive includes:
a polyvinyl-chloride resin;
a phthalate plasticizer;
a zero-tint antimony trioxide; and
an ultraviolet-light protectant that either absorbs ultraviolet light or reflects ultraviolet light.

5. The multilayer composite material of claim 1, wherein the polyvinyl-chloride adhesive includes:
a polyvinyl-chloride resin;
a phosphite plasticizer; and
an ultraviolet-light protectant that either absorbs ultraviolet light or reflects ultraviolet light.

6. The multilayer composite material of claim 1, wherein the ultraviolet-light inhibiting layer has either:
acrylic or polyvinylidene fluoride that also includes an ultraviolet-light protectant that either absorbs ultraviolet light or reflects ultraviolet light, or
a polyvinyl fluoride resin that also includes an ultraviolet-light protectant that either absorbs ultraviolet light or reflects ultraviolet light.

7. The multilayer composite material of claim 1, wherein the low-emissivity layer has a polyvinyl-fluoride film that includes an ultraviolet-light protectant that either absorbs ultraviolet light or reflects ultraviolet light.

8. A multilayer composite material comprising:
a core layer that is a saturated fabric, the saturated fabric including woven polyethylene-terephthalate yarns and a polyvinyl-chloride adhesive between the woven yarns;
the core layer having a first side and a second side;
the core-layer first side being attached to a first side of a first polyvinyl-chloride layer that includes a flame-retardant component;
the core-layer second side being attached to a first side of a second polyvinyl-chloride layer that includes a flame-retardant component;
the second side of the second polyvinyl-chloride layer being attached to a first side of an ultraviolet-light inhibiting layer that includes an ultraviolet-light protectant that either absorbs ultraviolet light or reflects ultraviolet light,
wherein the multilayer composite material has a range of light transmission from 30% to 90%, and
wherein the multilayer composite material has a tensile strength ranging from 150 pli to 650 pli.

9. The multilayer composite material of claim 8 further comprising an additional layer that is a low-emissivity layer that reduces the amount of infrared light that can pass through the low-emissivity layer.

10. The multilayer composite material of claim 8, wherein the polyethylene-terephthalate yarns include titanium dioxide.

11. The multilayer composite material of claim 8, wherein the polyethylene-terephthalate yarns do not include titanium dioxide.

12. The multilayer composite material of claim 8, wherein the polyvinyl-chloride adhesive includes:
a polyvinyl-chloride resin;
a phthalate plasticizer;
a zero-tint antimony trioxide; and
an ultraviolet-light protectant that either absorbs ultraviolet light or reflects ultraviolet light.

13. The multilayer composite material of claim 8, wherein the polyvinyl-chloride adhesive includes:
a polyvinyl-chloride resin;
a phosphite plasticizer; and
an ultraviolet-light protectant that either absorbs ultraviolet light or reflects ultraviolet light.

14. The multilayer composite material of claim 9, wherein the ultraviolet-light inhibiting layer has either:
acrylic or polyvinylidene fluoride that also includes an ultraviolet-light protectant that either absorbs ultraviolet light or reflects ultraviolet light, or
a polyvinyl fluoride resin that also includes an ultraviolet-light protectant that either absorbs ultraviolet light or reflects ultraviolet light.

15. The multilayer composite material of claim 9, wherein the low-emissivity layer has a polyvinyl-fluoride film that includes an ultraviolet-light protectant that either absorbs ultraviolet light or reflects ultraviolet light.

16. A multilayer composite material comprising:
a core layer that is an open weave polyester fabric saturated with cured vinyl plastisol;
the core layer having a first side and a second side;
the first side of the core layer being attached to a first side of a first vinyl film;
the second side of the core layer being attached to a first side of a second vinyl film;
the first vinyl film having a second side that is attached to a first side of a first protective layer that is either a film or lacquer; and
the second vinyl film having a second side that is attached to a first side of a second protective layer that is either a film or lacquer.

17. The multilayer composite material of claim 16, wherein the first protective layer is a lacquer selected from the group consisting of acrylic, a mixture of polyvinylchloride and acrylic, urethane, fluoropolymer, and combinations thereof.

18. The multilayer composite material of claim 16, wherein the second protective layer is a lacquer selected from the group consisting of acrylic, a mixture of polyvinylchloride and acrylic, urethane, fluoropolymer, and combinations thereof.

19. The multilayer composite material of claim 16, wherein the first protective layer is a polyvinyl-fluoride film.

20. The multilayer composite material of claim 16, wherein the second protective layer is a polyvinyl-fluoride film.

21. A multilayer composite material comprising:
a core layer that is a saturated fabric, the saturated fabric including an open weave of polyethylene-terephthalate yarns and cured vinyl plastisol between the yarns;
the core layer having a first side and a second side;
the first side of the core layer being attached to a first side of a first vinyl layer;
the second side of the core layer being attached to a first side of a second vinyl layer;
the first vinyl layer having a second side that is attached to a first side of a first protective layer that is either a film or lacquer; and
the second vinyl film having a second side that is attached to a first side of a second protective layer that is either a film or lacquer.

22. The multilayer composite material of claim 21, wherein the first protective layer is a lacquer selected from the group consisting of acrylic, a mixture of polyvinylchloride and acrylic, urethane, fluoropolymer, and combinations thereof.

23. The multilayer composite material of claim 21, wherein the second protective layer is a lacquer selected from the group consisting of acrylic, a mixture of polyvinylchloride and acrylic, urethane, fluoropolymer, and combinations thereof.

24. The multilayer composite material of claim 21, wherein the first protective layer is a polyvinyl-fluoride film.

25. The multilayer composite material of claim 21, wherein the second protective layer is a polyvinyl-fluoride film.
